(19) United States
(12) Patent Application Publication
(10) Pub. No.: US 2026/0236204 A1
(43) Pub. Date: Aug. 13, 2026

(54) INFORMATION PROCESSING SYSTEM, CLOUD PRINTING SERVICE SYSTEM, AND NON-TRANSITORY COMPUTER READABLE MEDIUM

(71) Applicant: FUJIFILM Business Innovation Corp., Tokyo (JP)

(72) Inventor: Tasuku TAKEDA, Kanagawa (JP)

(73) Assignee: FUJIFILM Business Innovation Corp., Tokyo (JP)

(21) Appl. No.: 19/314,702

(22) Filed: Aug. 29, 2025

(30) Foreign Application Priority Data
Feb. 12, 2025 (JP) 2025-021014

(51) Int. Cl. G06F 3/12; G06F 3/04842

(52) U.S. Cl. CPC G06F 3/1236; G06F 3/04842; G06F 3/1205; G06F 3/1285

(57) ABSTRACT

An information processing system includes a first processor included in a first information processing apparatus operated by a user; and a second processor included in a second information processing apparatus operated by the user using the first information processing apparatus connected to the second information processing apparatus, the second processor is configured to: while the first information processing apparatus is connected, in response to detection of occurrence of an event involving presentation of message information in the second information processing apparatus, notify the first processor of the occurrence of the event; and the first processor is configured to: detect occurrence of the event in the first information processing apparatus; while the user is operating the first information processing apparatus, cause a first display included in the first information processing apparatus to present as a main window a window presented on the first display by the first information processing apparatus; while the user is operating the second information processing apparatus, cause the first display to present as a main window a window presented by the second information processing apparatus; in response to detection of occurrence of the event in any of the information processing apparatuses, identify a window presented as the main window on the first display; and in response to the detection of the occurrence of the event, present, in the main window, event notification information reporting the occurrence of the event when the information processing apparatus whose window is presented as the main window on the first display has not detected the occurrence of the event.

### CROSS-REFERENCE TO RELATED APPLICATIONS

This application is based on and claims priority under 35 USC 119 from Japanese Patent Application No. 2025-021014 filed Feb. 12, 2025.

### BACKGROUND

### (i) Technical Field

The present disclosure relates to an information processing system, a cloud printing service system, and a non-transitory computer readable medium.

### (ii) Related Art

The use of cloud printing services has become widespread to implement printing in a system environment where no print server is installed in an office or to enable printing at any output destination. When using a cloud printing service, a user only needs to register a print job in a print server provided in the cloud to select a time to print and a printer as an output destination.

When a cloud printing service is used, a system having the following functionality is necessary on a service user side. FIG. 8 illustrates a block diagram of a basic system for implementing a cloud printing service in the related art.

FIG. 8 illustrates a cloud printing server 1, a personal computer (PC) 2, and a printer 3. The units 1 to 3 are connected to, for example, a network (not illustrated) such as the Internet and are communicatively connected with each other. The printer 3 may be an image forming apparatus such as a multifunction peripheral having a printing function.

The cloud printing server 1 is configured to provide a cloud printing function to an information processing apparatus such as the PC 2. The cloud printing function can be used with a cloud printing driver 5 installed on the PC 2. Printing can be performed using the cloud printing service with a Print Agent 6 installed on the printer 3.

Hereinafter, for example, pull printing will be briefly described as a process flow of cloud printing.

The cloud printing driver 5 on the PC 2 registers a print job in the cloud printing server 1 by uploading the print job (step S1). Thereafter, in response to an instruction from the user, the Print Agent 6 on the printer 3 presents a list of print jobs registered in the cloud printing server 1. In response to the user selecting a print job from the list, the Print Agent 6 sends to the cloud printing server 1 a request for transmission of the print job (step S2). The print job selected in response to the request for transmission is downloaded to the printer 3 (step S3). Then, the printer 3 performs the print job, which has been downloaded. That is, printing is performed (step S4).

Nowadays, work is sometimes performed at home, for example, by telecommuting. Even in such a case, the user may want to perform printing on a printer at home using the cloud printing service. However, a Print Agent function may be unusable depending on the capability of the printer (such as the performance of a central processing unit and the memory size).

It is possible to use the cloud printing service even at home by providing a PC at home with the Print Agent function. FIG. 9 illustrates a block diagram of a basic system for providing the cloud printing service in such a case.

FIG. 9 illustrates the cloud printing server 1 described above. The PC 2 in the office may be the same as the PC 2 in FIG. 8. In contrast, a printer 4 and a PC 9 are installed in a home 8. Unlike the printer 3 illustrated in FIG. 8, a Print Agent is not installed on the printer 4. Instead, a Print Agent 6 is installed on the PC 9. The PC 9 has a function of establishing remote desktop connection to the PC 2.

For example, when a user in the home 8 wants to print a document stored in the PC 2 using the printer 4, the user establishes remote desktop connection between the PC 9 and the PC 2 (step S11). Then, the user causes the PC 9 to present a window of the PC 2 on the screen and performs a predetermined operation in the window of the PC 2 presented by the PC 9 to upload a print job to the cloud printing server 1 (step S12).

Thereafter, the user causes the PC 9 to present a window of the PC 9 on the screen and performs a predetermined operation in the window of the PC 9, thereby sending to the cloud printing server 1 a request for transmission in the same manner as described above (step S13). In response to a print job being downloaded (step S14), the Print Agent 6 on the PC 9 provides the printer 4 with an instruction to print (step S15). The printer 4 performs printing in response to the instruction to print (step S16).

Examples of the related art include Japanese Unexamined Patent Application Publication No. 2015-228185 and No. 2019-008469.

### SUMMARY

Using a function such as remote desktop connection described above enables a first display included in a first information processing apparatus operated by a user to present a window presented by a second information processing apparatus connected to the first information processing apparatus. When performing an operation on the second information processing apparatus in the window presented by the second information processing apparatus, the user often enlarges the window presented by the second information processing apparatus, that is, uses the window expanded, for example, to the entire display screen of the first display. In such a case, a window presented by the first information processing apparatus is not presented on the first display. In contrast, when performing an operation on the first information processing apparatus in the window presented by the first information processing apparatus, the user often enlarges the window presented by the first information processing apparatus, that is, uses the window expanded, for example, to the entire display screen of the first display. Thus, the user usually operates one of the information processing apparatuses while changing the window presented on the first display to a window in which an operation is to be performed.

While the user causes the first display to present the window presented by the second information processing apparatus, an event involving presentation of message information may occur in the first information processing apparatus. In such a case, since the window presented by the first information processing apparatus is not presented on the first display, the user is not able to recognize the event that has occurred in the first information processing apparatus from a presented message.

Conversely, while the window presented by the first information processing apparatus is presented on the first display, an event involving presentation of message information may occur in the second information processing apparatus connected to the first information processing apparatus. In such a case, since the window presented by the second information processing apparatus is not presented on the first display, the user is not able to recognize the event that has occurred in the second information processing apparatus from a presented message.

Aspects of non-limiting embodiments of the present disclosure relate to, while a window of either the first information processing apparatus operated by a user or the second information processing apparatus connected to the first information processing apparatus and operated by the user is presented by the first information processing apparatus, notifying the user of occurrence of an event involving presentation of message information in another information processing apparatus.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an information processing system including a first processor included in a first information processing apparatus operated by a user; and a second processor included in a second information processing apparatus operated by the user using the first information processing apparatus connected to the second information processing apparatus. The second processor is configured to: while the first information processing apparatus is connected, in response to detection of occurrence of an event involving presentation of message information in the second information processing apparatus, notify the first processor of the occurrence of the event; and the first processor is configured to: detect occurrence of the event in the first information processing apparatus; while the user is operating the first information processing apparatus, cause a first display included in the first information processing apparatus to present as a main window a window presented on the first display by the first information processing apparatus; while the user is operating the second information processing apparatus, cause the first display to present as a main window a window presented by the second information processing apparatus; in response to detection of occurrence of the event in any of the information processing apparatuses, identify a window presented as the main window on the first display; and in response to the detection of the occurrence of the event, present, in the main window, event notification information reporting the occurrence of the event when the information processing apparatus whose window is presented as the main window on the first display has not detected the occurrence of the event.

### BRIEF DESCRIPTION OF THE DRAWINGS

An exemplary embodiment of the present disclosure will be described in detail based on the following figures, wherein:

FIG. 1 is a system block diagram illustrating the exemplary embodiment of an information processing system according to the present disclosure;

FIG. 2 illustrates a setting example of a presentation control table in the present exemplary embodiment;

FIG. 3 illustrates an example of an error message presented in a pcB window in the present exemplary embodiment;

FIG. 4 illustrates an example of a guide window superimposed on a pcA window in the present exemplary embodiment;

FIG. 5 illustrates another example of a guide window superimposed on a pcA window in the present exemplary embodiment;

FIG. 6 is a flowchart illustrating an error control process performed by the pcA in the present exemplary embodiment;

FIG. 7 is a flowchart illustrating an error control process performed by the pcB in the present exemplary embodiment;

FIG. 8 is a block diagram of a basic system for a cloud printing service in the related art; and

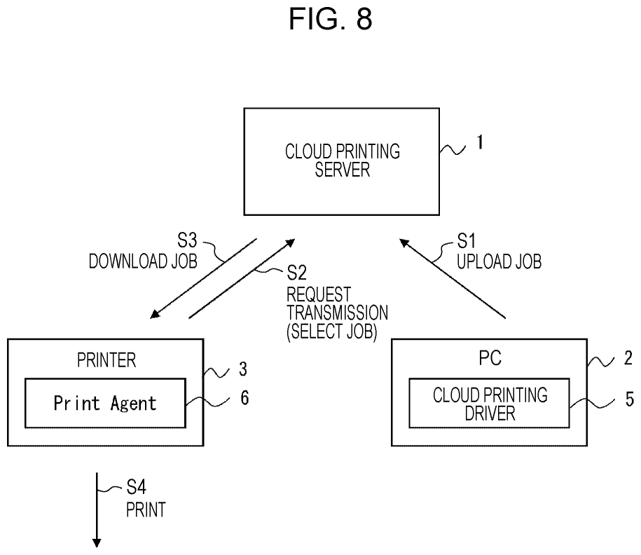

FIG. 9 is a block diagram of a system for a cloud printing service including remote desktop connection in the related art.

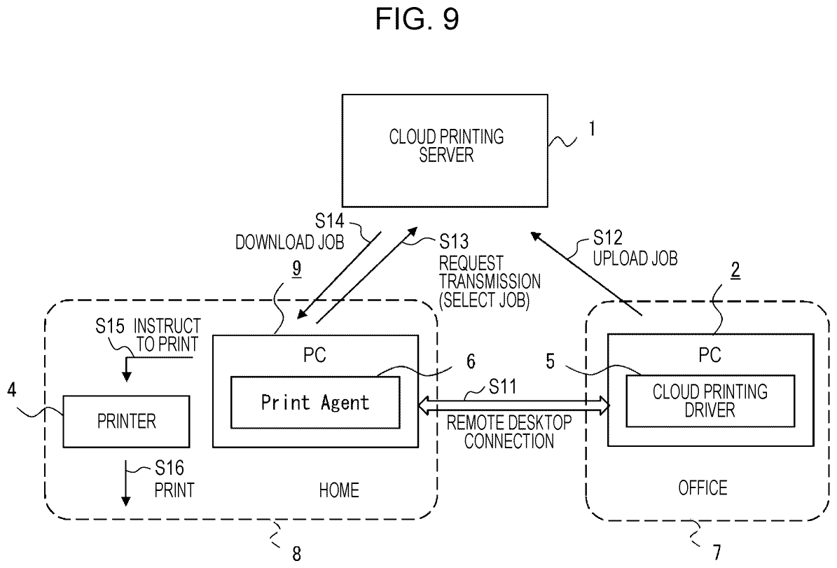

### DETAILED DESCRIPTION

Hereinafter, an exemplary embodiment of the present disclosure will be described with reference to the drawings.

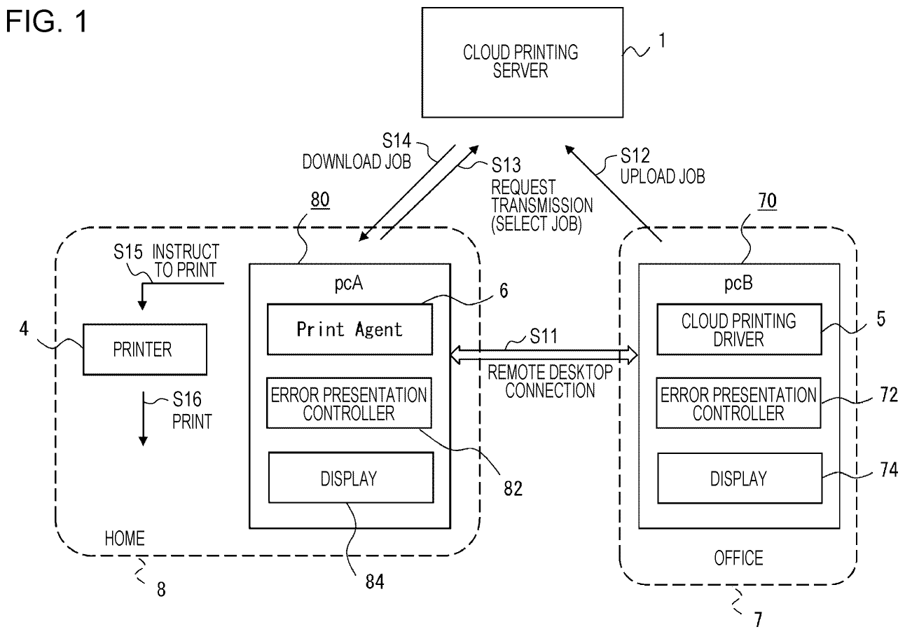

FIG. 1 is a system block diagram illustrating the exemplary embodiment of an information processing system according to the present disclosure. In FIG. 1, constituent elements that may be the same as those in the related art are denoted by the same reference symbols or numerals. FIG. 1 illustrates a cloud printing server 1, a PC 70 used in an office 7 of a user, a PC 80 used in a home 8 of the user, and a printer 4 as a printing apparatus connected to the PC 80. The cloud printing server 1 and the PCs 70 and 80 are connected to each other using a network such as the Internet (not illustrated).

The cloud printing server 1 is a server computer configured to provide a cloud printing service to users. The cloud printing server 1 is configured to manage print jobs received from a cloud printing driver 5. If a request for printing is provided as push printing, an output instruction is directly issued to a designated printer. For pull printing, a print job is stored in the cloud printing server 1 until an output instruction is requested.

The cloud printing driver 5 is installed on the PC 70 in the same manner as in the related art, and the PC 70 further includes an error presentation controller 72 and a display 74. The cloud printing driver 5 is an application configured to convert a print command from an application into a print job and transmit the print job to the cloud printing server 1. The error presentation controller 72 is configured to control presentation of error message information generated in the PC 70. An error is an example of an event involving presentation of message information. The display 74 is configured to present a window selected in response to a user operation. The display 74 is formed by components such as a display screen and an operation panel.

A Print Agent 6 is installed on the PC 80 in the same manner as in the related art, and the PC 80 further includes an error presentation controller 82 and a display 84. The Print Agent 6 is an application configured to receive an output instruction from the cloud printing server 1 and perform a printing process on the printer 4. For pull printing, a list of print jobs stored in the cloud printing server 1 is presented. The user can perform printing by selecting a print job to print. The error presentation controller 82 is configured to control presentation of error message information generated in the PC 80. The display 84 is configured to present a window selected in response to a user operation. The display 84 is formed by components such as a display screen and an operation panel.

The error presentation controllers 72 and 82 configured to provide characteristic processing functionality in the present exemplary embodiment perform expected functionality while the PC 70 and the PC 80 are connected via remote desktop connection.

The term “remote desktop” refers to a technique of accessing a PC or a server usually located at a different place via a network and remotely operating the PC or the server using a terminal such as a PC at hand. In the present exemplary embodiment, the PC 80 corresponds to the terminal such as a PC at hand and corresponds to a first information processing apparatus operated by the user. The PC 70 corresponds to the PC located at a different place and corresponds to a second information processing apparatus operated by the user using the PC 80 while remote desktop connection to the PC 80 is maintained. Thus, a window presented on the screen of the PC 70 at a remote location can be presented on the display 84 of the PC 80.

In the present exemplary embodiment, the PCs 70 and 80 can be constructed using general-purpose hardware components existing in the related art. That is, the PCs 70 and 80 each include a processor, a read-only memory (ROM), a random-access memory (RAM), a hard disk drive (HDD) as a storage unit, a network interface (IF) provided as a communication unit, and a user interface including an input unit such as a mouse or a keyboard and a presentation unit such as a display screen. In the present exemplary embodiment, the processor included in the PC 80 corresponds to a first processor, and the processor included in the PC 70 corresponds to a second processor.

In addition to the components illustrated in FIG. 1, the PCs 70 and 80 include components that can be included in an ordinary computer and, for example, a component for remote desktop connection, but these components are not characteristic components for the present disclosure and are thus omitted from the drawings. The cloud printing server 1 can also be constructed using hardware components of a general-purpose server computer existing in the related art.

In the information processing system illustrated in FIG. 1, the user can use a cloud printing service in the same procedure as in the related art. When the user in the home 8 wants to print a document stored in the PC 70 using the printer 4, the user connects the PC 80 to the PC 70 via remote desktop connection (step S11). Then, the user causes the PC 80 to present a window of the PC 70 on the display 84 and performs a predetermined operation in the window of the PC 70 presented on the display 84 of the PC 80, thereby uploading a print job to the cloud printing server 1 (step S12).

Thereafter, the user causes the PC 80 to present a window of the PC 80 on the display 84 and performs a predetermined operation in the window of the PC 80, thereby sending to the cloud printing server 1 a request for transmission (step S13). In response to a print job being downloaded, the Print Agent 6 on the PC 80 acquires the print job (step S14) and provides the printer 4 with an instruction to print (step S15). The printer 4 performs printing in response to the instruction to print (step S16).

Terms to be used in the following description will be described herein.

A “window” refers to an area presented on a screen of a PC, such as the PC 70 or 80, in response to an application or a folder being opened. A window is generally rectangular in shape. The size of a window depends on an application and can be changed by a user operation. Although some windows have a fixed size, description will be given in the present exemplary embodiment on the assumption that the size can be changed. However, in the present exemplary embodiment, it is assumed that a window is presented on the entire screen of the PC 70 or 80 unless otherwise specified.

The displays 74 and 84 each correspond to a presentation unit such as a display screen. Thus, what are referred to as the displays 74 and 84 are the same as what are referred to as the screens of the PCs 70 and 80, respectively, in the following description. In other words, a window is presented on the displays 74 and 84 as a physical screen. While remote desktop connection is not established, a window presented on the screen of the PC 70 is referred to as a “window presented on the display 74”, and a window presented on the screen of the PC 80 is referred to as a “window presented on the display 84”. While remote desktop connection is maintained, either a “window presented on the display 74” or a “window presented on the display 84” is selectively presented on the entire screen of the PC 80. The user can cause the PC 80 to present a window that is not presented on the screen of the PC 80 by performing a predetermined window switching operation.

In the following description, an expression “active window” is used. A window that is “active” is located at the forefront among a plurality of windows that are activated in a PC and is ready to accept an operation with a mouse or a character input with a keyboard. An “active window” corresponds to a “main window”. In contrast, of the windows that can be presented on the screen of the PC 80 (that is, a “window presented on the display 74” or a “window presented on the display 84”), the window that is not the active window corresponds to a “sub-window”. A “sub-window” is also referred to as an “inactive window”.

In the following description, a “window presented on the display 84” is referred to as a “pcA window”, and a “window presented on the display 74” is referred to as a “pcB window”. While remote desktop connection is maintained, the pcA window is the active window if the pcA window is presented on the screen of the PC 80 and is being operated by the user. In contrast, the pcB window is the active window if the pcB window is presented on the screen of the PC 80 and is being operated by the user.

Next, an operation performed when an error has occurred in the present exemplary embodiment will be described. For convenience of description, an error related to the provision of a cloud printing service will be described as an example.

The error presentation controllers 72 and 82 according to the present exemplary embodiment perform expected functionality while the PC 70 and the PC 80 are connected via remote desktop connection. Without remote desktop connection between the PC 70 and the PC 80, the cloud printing driver 5 presents an error message on the display 74 in response to detection of an error in the PC 70 in the same manner as in the related art. In contrast, the Print Agent 6 presents an error message on the display 84 in response to detection of an error in the PC 80 in the same manner as in the related art. Without remote desktop connection between the PC 70 and the PC 80, the PC 70 and the PC 80 are generally unable to recognize an error that has occurred in the other apparatus. Thus, an error message presented on the display 74 of the PC 70 is not presented on the display 84. Similarly, an error message presented on the display 84 of the PC 80 is not presented on the display 74.

With remote desktop connection between the PC 70 and the PC 80, cooperation between the error presentation controller 72 and the error presentation controller 82 enables detection of an error in either the PC 70 or 80 to be reported to the other PC via a virtual private network (VPN) established based on remote desktop connection.

As described above, if it is assumed that the user actually operates the PC 80 installed in the home 8, only the active window, that is, either a “window presented on the display 74” (hereinafter, referred to as the “pcB window”) or a “window presented on the display 84” (hereinafter, referred to as the “pcA window”), is presented on the entire screen of the PC 80.

When the pcA window is presented on the screen of the PC 80, in other words, when the pcA window is the active window, in response to occurrence of an error in the PC 70, the cloud printing driver 5 tries to notify the user by presenting a message indicating the error as event notification information in the pcB window. However, the pcA window is presented on the screen of the PC 80, and the pcB window is not presented. Thus, the user is not able to recognize the error that has occurred in the PC 70 from the message.

Conversely, when the pcB window is presented on the screen of the PC 80, in other words, when the pcB window is the active window, in response to occurrence of an error in the PC 80, the Print Agent 6 tries to notify the user by presenting a message indicating the error as event notification information in the pcA window. However, the pcB window is presented on the screen of the PC 80, and the pcA window is not presented. Thus, although using the PC 80, the user is not able to recognize the error that has occurred in the PC 80 from the message.

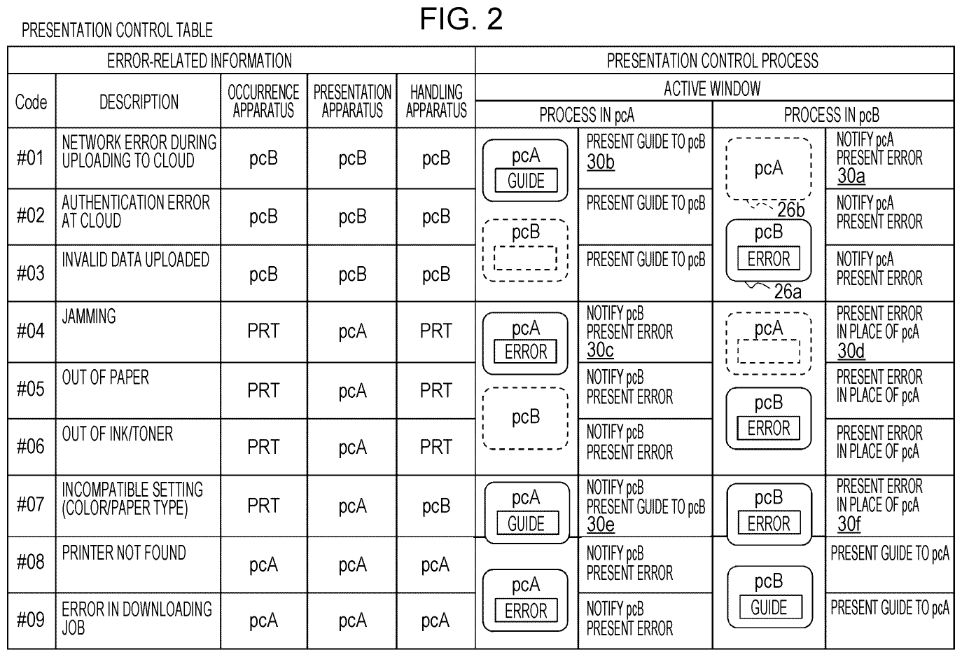

In the present exemplary embodiment, even when a window of a PC in which an error has occurred is not presented on the screen of the PC 80, it is possible to notify the user that an error has occurred in a PC whose window is not presented. In the present exemplary embodiment, the error presentation controllers 72 and 82 perform a characteristic presentation control in cooperation with each other, and details of the presentation control are illustrated in a table format in FIG. 2.

FIG. 2 illustrates details of an example of a presentation control table. As illustrated in the presentation control table, error-related information regarding an error that occurs is associated with an outline of a presentation control process performed when the error has occurred. In FIG. 2, the PC 70 is denoted by “pcB”, the PC 80 is denoted by “pcA”, and the printer 4 is denoted by “PRT”.

In the error-related information, an error code for identifying an error is associated with a description of the error, an apparatus in which the error occurs (“occurrence apparatus”), an apparatus that presents a message corresponding to the error that occurs (“presentation apparatus”), and an apparatus to be used when recovering from the error (“handling apparatus”).

Among the errors described above, errors corresponding to the error codes “#01” to “#03” are related to uploading, occur in the PC 70 (pcB), and are detected by the cloud printing driver 5, and the error message is presented on the display 74 of the PC 70 (pcB). These errors can be recovered by the PC 70 (pcB).

Errors corresponding to the error codes “#04” to “#06” are related to the printer 4, occur in the printer 4, and are detected by the printer 4 (PRT), and the Print Agent 6 presents the error message on the display 84 of the PC 80 (pcA) upon receiving a notification from the printer 4. These errors can be recovered by the printer 4 (PRT).

An error corresponding to the error code “#07” is related to print setting, occurs in the printer 4 (PRT), and is detected by the printer 4, and the Print Agent 6 presents the error message on the display 84 of the PC 80 (pcA) upon receiving a notification from the printer 4. This error can be recovered by the PC 70 (pcB).

Errors corresponding to the error codes “#08” and “#09” are related to communication, occur in the PC 80 (pcA), and are detected by the Print Agent 6, and the error message is presented on the display 84 of the PC 80 (pcA). These errors can be recovered by the PC 80 (pcA).

The presentation control processes illustrated in FIG. 2 are performed by the error presentation controller 72 and the error presentation controller 82 operating in cooperation with each other. Each error is associated with a corresponding presentation control process. As is clear from FIG. 2, even for the same error, a presentation control process to be performed depends on whether the active window is the pcA window or the pcB window.

The presentation control processes in FIG. 2 schematically illustrate presentation states of the screen of the PC 80. In FIG. 2, a window 26a indicated by a solid line is the active window, and a window 26b indicated by a dashed line is not the active window. The term “ERROR” in the windows 26a and 26b indicates that an error message is associated.

For example, when an error having one of the error codes “#01” to “#03” occurs while the pcB window is the active window, the pcB window is presented on the screen of the PC 80, and the pcA window is not presented. The error message at the time of this error is presented in the pcB window, that is, on the screen of the PC 80 since the pcB window is the active window. Thus, the user is able to recognize that an error has occurred in the PC 70.

In contrast, when an error having one of the error codes “#01” to “#03” occurs while the pcA window is the active window, the pcA window is presented on the screen of the PC 80, and the pcB window is not presented. The error message at the time of this error is presented in the pcB window but is not presented on the screen of the PC 80 since the pcB window is not the active window. Thus, the user is not able to recognize the error that has occurred in the PC 70 from the message.

In the present exemplary embodiment, it is possible to notify the user of an error that has occurred in any of the PCs 70 and 80 regardless of which window is presented on the screen of the PC 80. A case where an error having the error code “#01” (a network error during uploading to cloud) occurs will be specifically described herein as an example.

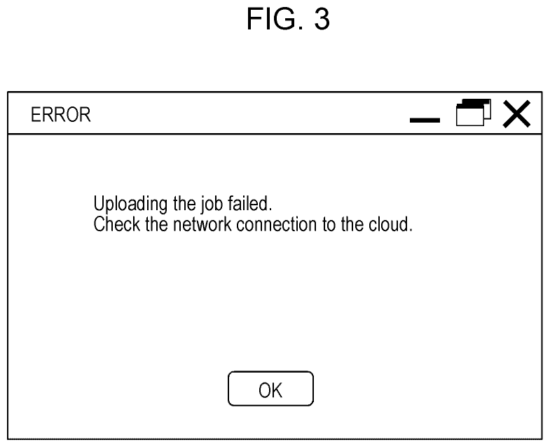

When the cloud printing driver 5 detects the occurrence of an error having the error code “#01”, the error presentation controller 72 performs control to present an error message window illustrated in FIG. 3, which is to be presented by the cloud printing driver 5, such that the error message window is superimposed on the pcB window. This error message window may be the same as in the related art. Presenting an error message window superimposed on the pcB window is also simply referred to as “presenting an error message in the pcB window”. A similar phrase is also used for the pcA window.

If the pcB window, in which an error message is presented, is the active window, the user is able to recognize the error that has occurred in the PC 70 from this error message since the pcB window is presented on the screen of the PC 80 as illustrated in FIG. 2.

In contrast, if the pcA window is the active window, the pcB window, in which the error message is presented, is not presented on the screen of the PC 80. In such a case, the error presentation controller 72 performs control to present an error message in the pcB window, and notifies the error presentation controller 82 in the pcA of the occurrence of the error along with the error code (“#01” in this example) of the error that has occurred (process 30a illustrated in FIG. 2).

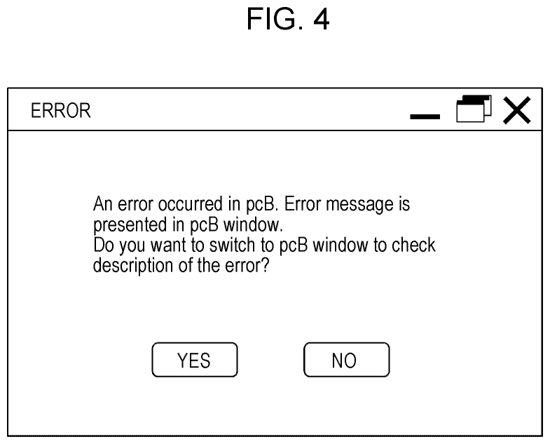

In response to this notification, the error presentation controller 82 presents a guide in the pcA window, which is the active window, to change the active window to the pcB window (process 30b). FIG. 4 illustrates an example of the window for presenting a guide superimposed on the pcA window (hereinafter, also referred to as a “guide window”). The guide window includes a message for notifying the user that an error message is presented in the window of a PC in which the occurrence of an error has been detected, in this example, the pcB, and a selection button “YES” for designating the pcB window, in which the error message is presented, as the active window.

If the user wants to have the pcB window presented, and more particularly if the user wants to change the active window from the pcA window to the pcB window, the user selects “YES” in the guide window illustrated in FIG. 4. In response to this selecting operation, the error presentation controller 82 changes the active window to the pcB window.

As another example, a case where an error having the error code “#04” (jamming) occurs will be specifically described as an example.

When the printer 4 detects the occurrence of a jamming error, the Print Agent 6 detects the occurrence of the error in response to the notification of the occurrence of the error from the printer 4. The error presentation controller 82 performs control to present in the pcA window an error message to be presented by the Print Agent 6 in the same manner as in the related art. If the pcA window, in which the error message is presented, is the active window, the user is able to recognize the error that has occurred in the printer 4 from this error message since the pcA window is presented on the screen of the PC 80.

In contrast, if the pcB window is the active window, the pcA window, in which the error message is presented, is not presented on the screen of the PC 80. In such a case, the error presentation controller 82 notifies the error presentation controller 72 that an error having the error code “#04” has occurred (process 30c). At this time, error message information presented in the pcA window is transmitted. Although the pcA window is not presented on the screen of the PC 80, the error presentation controller 82 may perform control to present an error message in the pcA window in the same manner as in the related art. Control may be performed not to present the error message in the pcA window. Alternatively, control may be performed to present a guide window to change the active window to the pcA window.

Upon receiving the notification from the error presentation controller 82, the error presentation controller 72 performs control to present the error message in the pcB window, which is the active window, instead of in the pcA window (process 30d). This enables the user to recognize that an error has occurred in the printer 4 even while the window of the pcB, in which no error has occurred, is presented.

As still another example, a case where an error having the error code “#07” (incompatible setting) occurs will be specifically described as an example.

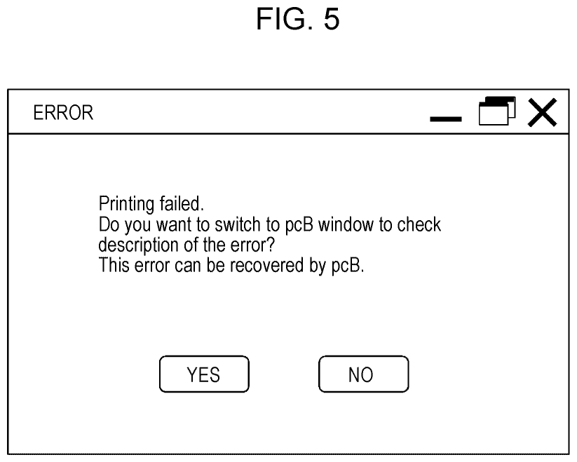

This error occurs, for example, when a color printing attribute is set to a job although the printer 4 does not have color printing functionality. When the printer 4 detects the occurrence of an incompatible setting error while the pcA window is the active window, the error presentation controller 82 performs control to present a guide window for changing the active window to the pcB window in response to notification of the occurrence of the error from the printer 4, as illustrated in FIG. 5. The error presentation controller 82 may present an error message to be presented by the Print Agent 6 in the same manner as in the related art, but performs control to present a window for a guide from the beginning only for this error (process 30e).

As is apparent from the error-related information illustrated in FIG. 2, this error can be eliminated by the pcB. Thus, the guide window is designed with an intention somewhat different from the intention for the guide window illustrated in FIG. 4, which prompts the user to check the error message. The guide window is designed to prompt the user to change the active window to the pcB window since the pcB window is used to handle the error and an operation needs to be performed in the pcB window.

In contrast, while the pcB window is the active window, the error presentation controller 82 notifies the error presentation controller 72 that an error having the error code “#07” has occurred. At this time, an error message to be presented in the pcA window is transmitted. Upon receiving the notification from the error presentation controller 82, the error presentation controller 72 performs control to present in the pcB window, instead of in the pcA window, the error message to be presented in the pcA window since the pcB window is the active window (process 30f).

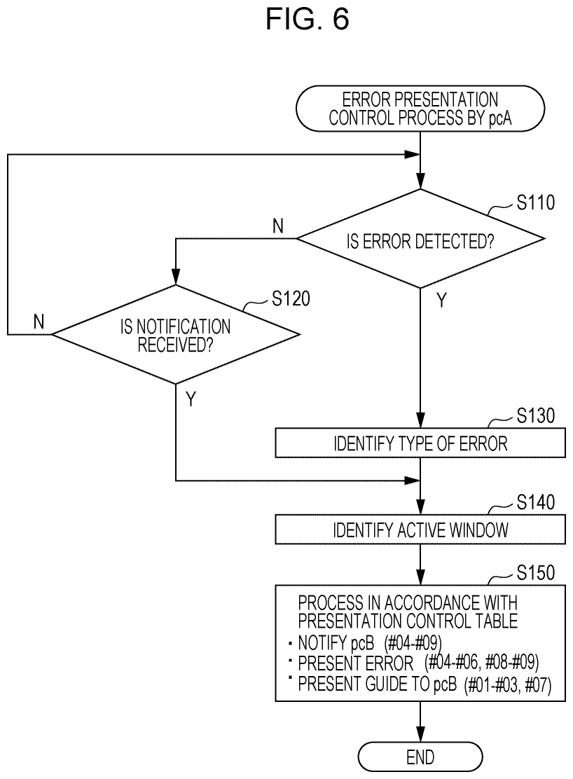

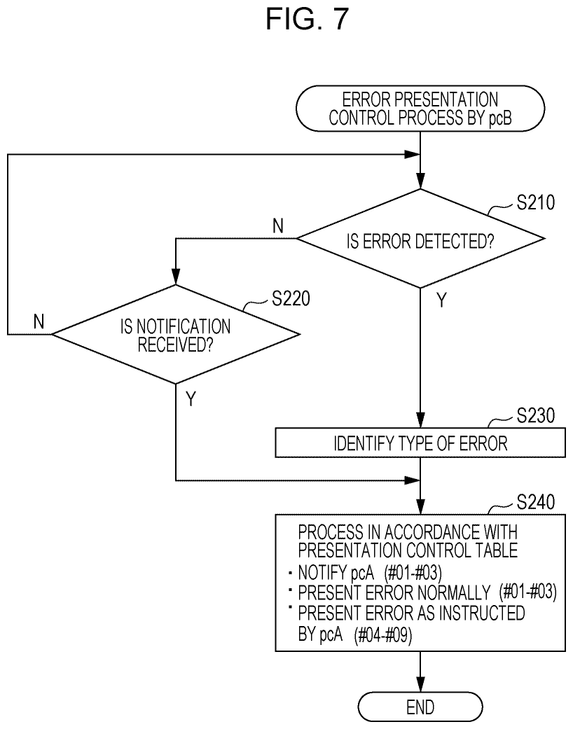

The processes performed by the error presentation controllers 72 and 82 have been described above with reference to the presentation control table illustrated in FIG. 2. FIG. 6 is a flowchart illustrating an error presentation control process performed by the pcA. FIG. 7 is a flowchart illustrating an error presentation control process performed by the pcB. Hereinafter, details of the error presentation control process performed in each of the PCs 70 and 80 will be described with reference to the corresponding flowchart. In the description of the flowchart, the PC 80 is referred to as the “pcA”, and the PC 70 is referred to as the “pcB”.

When performing the error presentation control processes, the PCs 70 and 80 may perform processes of checking in advance, for example, that the PCs 70 and 80 have functionality necessary for interactively performing the error presentation control processes and that the PCs 70 and 80 are in an environment that allows the cloud printing service to be used (for example, the cloud printing driver 5 or the Print Agent 6 is installed).

The functionality provided by the error presentation controllers 72 and 82 works as expected on the assumption that remote desktop connection is maintained. Thus, the error presentation controllers 72 and 82 may be activated when remote desktop connection is established, and may be terminated when remote desktop connection is disabled. Alternatively, when being activated, the error presentation controllers 72 and 82 may perform a process of checking that remote desktop connection is established, and if the connection is not established, the error presentation controllers 72 and 82 may perform a process of establishing the connection or may terminate without performing the error presentation control process.

First, as illustrated in FIG. 6, the Print Agent 6 monitors whether an error has occurred in the pcA or the printer 4. If no error is detected (N in step S110), and if no notification is received from the pcB (N in step S120), the process returns to step S110. If occurrence of an error is detected by the Print Agent 6 (Y in step S110), the error presentation controller 82 identifies the type of the error (step S130). In the present exemplary embodiment, the type of the error designated in the presentation control table illustrated in FIG. 2 is identified.

If a notification is received from the pcB (Y in step S120), since the notification contains the type of the error identified by the pcB, the error presentation controller 82 can determine the type of the error regardless of whether the error occurs in the pcA or the pcB.

When an error occurs in the pcA or the printer 4, the Print Agent 6 presents an error message on the display 84 in the same manner as in the related art, but the error presentation controller 82 controls the presentation of the message by the Print Agent 6. Thus, for example, the error presentation controller 82 can perform control not to present a message to be presented by the Print Agent 6.

Subsequently, the error presentation controller 82 identifies a window currently presented on the display 84 as the active window (step S140). The behavior of the error presentation controller 82 depends on the active window. As described above, the error presentation controller 82 performs a process in accordance with the presentation control processes designated in the presentation control table (step S150).

For example, when an error having one of the error codes “#04” to “#06”, for which an error message is presented by the pcA, occurs while the active window is the pcA window, the error presentation controller 82 may present an error message in the pcA window in the same manner as in the related art. In contrast, if the active window is the pcB window, since the pcB cannot detect the occurrence of an error in the printer 4, the error presentation controller 82 notifies the error presentation controller 72 in the pcB of the occurrence of an error, an error code, the active window, an instructions for a process to be performed, error message information, and other information. In this way, the error presentation controller 72 can present the error message in the pcB window, which is the active window, instead of in the pcA.

Next, an error presentation control process performed by the pcB will be described with reference to a flowchart illustrated in FIG. 7.

The cloud printing driver 5 monitors whether an error has occurred in the pcB. If no error is detected (N in step S210), and if no notification is received from the pcA (N in step S220), the process returns to step S210. If occurrence of an error is detected by the cloud printing driver 5 (Y in step S210), the error presentation controller 72 identifies the type of the error (step S230). In the present exemplary embodiment, the type of the error designated in the presentation control table illustrated in FIG. 2 is identified.

If a notification is received from the pcA (Y in step S220), since the notification contains the type of the error identified by the pcA (that is, an error code), the error presentation controller 72 can determine the type of the error regardless of whether the error occurs in the pcA or the pcB.

When an error occurs in the pcB, the cloud printing driver 5 presents an error message on the display 74 in the same manner as in the related art, but the error presentation controller 72 controls the presentation of the message by the cloud printing driver 5. Thus, for example, the error presentation controller 72 can perform control not to present a message to be presented by the cloud printing driver 5.

Subsequently, as described above, the error presentation controller 72 performs a process in accordance with the presentation control processes designated in the presentation control table (step S240).

For example, when an error having one of the error codes “#01” to “#03”, for which an error message is presented by the pcB, occurs, the error presentation controller 72 notifies the error presentation controller 82 in the pcA of the occurrence of the error together with an error code.

Upon receiving the notification of the occurrence of the error from the error presentation controller 82 in the pcA, the error presentation controller 72 performs a presentation control process in accordance with a processing instruction contained in the notification of the error. For example, for an error having one of the error codes “#04” to “#07”, since the error presentation controller 72 receives error message information from the error presentation controller 82, the error presentation controller 72 refers to the error message information and presents an error message or other information in the pcB window instead of in the pcA window. In particular, for an error having the error code “#07”, the user refers to the error message presented in the pcB window and can take a measure to eliminate the error, that is, an incompatible setting, in the pcB window.

An error message presented in the pcA window or the pcB window may be an error message held by the pcA or the pcB, or an error message may be completed based on error message information sent from the other PC and then presented.

In the present exemplary embodiment, the descriptions of the presentation control processes performed by the error presentation controllers 72 and 82 are provided in the form of the presentation control table illustrated in FIG. 2 for convenience. The error presentation controllers 72 and 82 may perform the presentation control processes by referring to a presentation control table set in any of the storage units. Alternatively, the flow of each presentation control process illustrated in the presentation control table may be incorporated into an application for implementing processing functionality in the error presentation controllers 72 and 82.

In the present exemplary embodiment, the description has been provided on the assumption that the active window is presented on the entire screen of the PC 80. In other words, a window presented on the entire screen of the PC 80 is identified as the active window. No part of the window that is not the active window (referred to as an “inactive window” herein) is presented on the screen of the PC 80. However, as described above, the size of a window can actually be changed. Although there may be only one active window, it is possible to simultaneously present both the active window and the inactive window on the screen of the PC 80 by adjusting the sizes of the pcA window and the pcB window. If both windows are presented, it may be impossible to determine which window is the active window. Thus, several examples of a method for identifying the active window when both the pcA window and the pcB window are simultaneously presented on the screen of the PC 80 will be described below.

In these examples, only two windows, that is, the pcA window and the pcB window, are assumed to be presented on the screen of the PC 80. The size of a window (that is, a display area) is assumed to be 100% when the window is presented so as to cover the entire screen of the PC 80, and the display area of a window is assumed to be 0% when the window is not presented on the screen of the PC 80, in other words, when the window is minimized.

The pcA window is usually presented on the screen of the PC 80 since the pcA window refers to a window presented on the display 84. When the pcA is connected to the pcB via remote desktop connection, the pcB window can also be presented on the screen of the PC 80.

When the pcB window is presented on the screen of the PC 80 via remote desktop connection, it is possible to initially set the size of the display area of the pcB window. For example, if the display area is initially set to 80% when the pcB window is presented on the screen of the PC 80, the pcB window is presented so that the display area covers 80% of the entire screen of the PC 80. More specifically, the pcB window is presented so as to cover 80% of the pcA window, which is presented on the entire screen of the PC 80. The size of the display area of the pcB window is set to 100% when the display area covers 80% of the entire screen of the PC 80 as defined in the initial setting. That is, although the display area of the pcB window may cover 80% of the entire screen of the PC 80, the size of the display area defined in the initial setting is 100%, and the pcB window is not presented on the screen of the PC 80 in a size larger than this size.

A first method of identifying the active window is based on the size of the display area of the pcB window. If the display area of the pcB window is larger than 0%, that is, if the pcB window is at least presented on the screen of the PC 80, the pcB window is identified as the active window. Otherwise, that is, when the size of the display area of the pcB window is 0% on the screen of the PC 80, in other words, when the pcB window is not presented on the screen of the PC 80, the pcA window is identified as the active window. Here, 0% is used as a criterion, but the criterion need not be 0%.

A second method of identifying the active window is based on a scaling ratio for the display area of the pcB window. When the size of the display area of the pcB window is initially set to 80%, this size is 100% of the size of the pcB window as described above. If the scaling ratio for the display area of the pcB window, which is defined with respect to the size that is initially set, is currently equal to or larger than a predetermined threshold, the pcB window is identified as the active window. Otherwise, that is, if the scaling ratio for the pcB window is currently less than the predetermined threshold, the pcA window is identified as the active window.

A third method of identifying the active window is based on the size of the display area of the pcB window with respect to the size of the screen of the PC 80. Of the display area of the pcB window, only an area located within the screen of the PC 80 is regarded as the display area when the size of the display area of the pcB window is referred to. If a scaling ratio for the display area of the pcB window is currently equal to or larger than a predetermined threshold, the pcB window is identified as the active window. Otherwise, that is, if the scaling ratio for the pcB window is currently less than the predetermined threshold, the pcA window is identified as the active window.

A fourth method of identifying the active window is based on a presentation mode of a window for presenting an error message. For example, when an error message is presented in the pcB window, if the window for presenting the error message fits within the range of the screen of the PC 80, the pcB window is identified as the active window. Otherwise, the pcA window is identified as the active window.

The four methods of identifying the active window have been described as above, but the active window may be identified using other identifying methods.

When the active window is changed, the size of the pcA window or the pcB window presented as the active window on the screen of the PC 80 may be appropriately set. In the above description, it is assumed that a window is presented on the entire screen of the PC 80, that is, the window is maximized, but this is not meant to be limiting. Similarly, when the active window is changed to the inactive window, the size of the inactive window may be appropriately set. In the above description, a window is minimized so as not to be presented on the screen of the PC 80, but this is not meant to be limiting, and the window may be presented in a desired display area. Alternatively, the display mode may be changed to, for example, semi-transparency.

A position at which the window for presenting an error message is presented need not coincide with the fixed positions for the pcA window and the pcB window and may be determined according to other factors. Examples of the other factors include the position of a mouse cursor and the position of the line of sight of the user for a PC equipped with a camera.

When both the pcA window and the pcB window are presented, presentation of a guide window may be controlled. For example, if an error having the error code “#01” occurs while the pcA window is the active window, the error presentation controller 82 presents a guide window in the pcA window to prompt the user to change to the pcB window. At this time, the error presentation controller 82 may control the position at which the guide window is presented. For example, the error presentation controller 82 may present the guide window so that the guide window overlaps both the pcA window and the pcB window. Alternatively, the error presentation controller 82 may present the guide window so that the guide window moves in the direction from the pcA window to the pcB window to indicate the moving direction, or may present a symbol such as an arrow indicating the moving direction together with the guide window.

In the present exemplary embodiment, errors related to the provision of the cloud printing service have been described as an example, but the present exemplary embodiment may be applied to an error that occurs when another service is provided. In the present exemplary embodiment, an error has been described as an example of an event involving presentation of message information, but this is not meant to be limiting. An event need not be limited to an error as long as message information is presented in response to the occurrence of the event.

In the exemplary embodiments, the processes are performed by any computer. The computer may perform the processes by using a processor serving as hardware, a program serving as software, or combination of these. In this case, the processor is configured to perform the processes in the exemplary embodiments in cooperation with the program and may function as a unit or a means in the exemplary embodiments. The order in which the processor performs the processes is not limited to the described order and may be changed appropriately. The computer may be a general-purpose computer, an application specific computer, a workstation, or another system capable of performing the processes.

The processor may be composed of one or more pieces of hardware, and the type of the hardware is not limited. For example, the processor may be composed of hardware such as a central processing unit (CPU), a micro processing unit (MPU), a programmable logic device such as a field programmable gate array (FPGA), a dedicated circuit for performing specific processing such as an application specific integrated circuit (ASIC), a graphics processing unit (GPU), or a neural processing unit (NPU). Regarding the type of the hardware, different types of hardware may be combined. If multiple pieces of hardware are configured to perform one or more processes of the processor, the multiple pieces of hardware may be present in apparatuses physically away from each other or may be present in one apparatus. In each of exemplary embodiments, the order in which the processor performs the processes is not limited to the order described above and may be changed appropriately. The hardware is composed of electric circuitry in which circuit elements such as semiconductor devices are combined, or the like.

Further, the program may be software such as firmware or microcode. The program may be, for example, a program module group, and the functions thereof may be implemented by processors configured to implement the respective functions. The program may be program code or multiple code segments stored in one or more non-transitory computer readable media (for example, a storage medium or another storage). The program may be stored in such a divided manner in multiple non-transitory computer readable media present in apparatuses physically away from each other. The program code or the code segments may represent a procedure, a function, a sub program, a routine, a subroutine, a module, a software package, a class or any combination of instructions, data structures, or program statements. The program code or the code segment may be connected to another code segment or a hardware circuit by transmitting and/or receiving information, data, an argument, a parameter, or memory content.

The present disclosure is applicable to a program and a program product.

### Appendix

(((1)))

An information processing system comprising:
a first processor included in a first information processing apparatus operated by a user; and
a second processor included in a second information processing apparatus operated by the user using the first information processing apparatus connected to the second information processing apparatus,
wherein the second processor is configured to:
while the first information processing apparatus is connected, in response to detection of occurrence of an event involving presentation of message information in the second information processing apparatus, notify the first processor of the occurrence of the event; and
wherein the first processor is configured to:
detect occurrence of the event in the first information processing apparatus;
while the user is operating the first information processing apparatus, cause a first display included in the first information processing apparatus to present as a main window a window presented on the first display by the first information processing apparatus;
while the user is operating the second information processing apparatus, cause the first display to present as a main window a window presented by the second information processing apparatus;
in response to detection of occurrence of the event in any of the information processing apparatuses, identify a window presented as the main window on the first display; and
in response to the detection of the occurrence of the event, present, in the main window, event notification information reporting the occurrence of the event when the information processing apparatus whose window is presented as the main window on the first display has not detected the occurrence of the event.
   (((2)))

The information processing system according to (((1))),
wherein the event notification information includes a message indicating the information processing apparatus that has detected the occurrence of the event.
   (((3)))

The information processing system according to (((1))) or (((2))),
wherein the first processor is configured to present a guide window including the event notification information and a selection button for designating as a main window a window in which the message information is presented.
   (((4)))

The information processing system according to any one of (((1))) to (((3))),
wherein the first processor is configured to present, in the main window, event handling information indicating the information processing apparatus to be used to handle the event when the information processing apparatus whose window is presented as the main window on the first display is different from the information processing apparatus to be used to handle the event whose occurrence has been detected.
   (((5)))

The information processing system according to any one of (((1))) to (((4))),
wherein the first processor is configured to, by referring to the event handling information in which description of the event is associated with the information processing apparatus to be used to handle the event, determine whether the information processing apparatus whose window is presented as the main window on the first display is the same as the information processing apparatus to be used to handle the event whose occurrence has been detected.
   (((6)))

The information processing system according to any one of (((1))) to (((4))),
wherein the first processor is configured to present a guide window including the event handling information and a selection button for designating as a main window a window presented by the information processing apparatus to be used to handle the event.
   (((7)))

The information processing system according to any one of (((1))) to (((4))),
wherein the first processor is configured to, when a window of the information processing apparatus to be used to handle the event is presented as a sub-window on the first display, provide indication for prompting presentation of the sub-window as a main window.
   (((8)))

The information processing system according to any one of (((1))) to (((7))),
wherein the first processor is configured to control a position at which a window for presenting the event handling information is presented.
   (((9)))

An information processing system comprising:
a first processor included in a first information processing apparatus operated by a user,
wherein the first processor is configured to:
connect a second information processing apparatus operated by the user to the first information processing apparatus using the first information processing apparatus;
detect occurrence of an event involving presentation of message information in the first information processing apparatus;
while the user is operating the first information processing apparatus, cause a first display included in the first information processing apparatus to present as a main window a window presented on the first display by the first information processing apparatus;
while the user is operating the second information processing apparatus, cause the first display to present as a main window a window presented by the second information processing apparatus;
in response to detection of occurrence of the event in any of the information processing apparatuses, identify a window presented as the main window on the first display; and
in response to the detection of the occurrence of the event, present, in the main window, event notification information reporting the occurrence of the event when the information processing apparatus whose window is presented as the main window on the first display has not detected the occurrence of the event.
   (((10)))

The information processing system according to (((1))) or (((9))),
wherein the event is an error that occurs in the first information processing apparatus, the second information processing apparatus, or an apparatus connected to the first information processing apparatus.
   (((11)))

A cloud printing service system comprising:
the information processing system according to any one of (((1))) to (((10)));
a server configured to provide a cloud printing service; and
a printing apparatus connected to the first information processing apparatus,
wherein a print agent application is installed on the first information processing apparatus,
a cloud printing driver is installed on the second information processing apparatus, and
the first information processing apparatus is configured to, in response to a user operation, acquire a job registered in the server by the second information processing apparatus and cause the printing apparatus to print the job.
   (((12)))

A program causing a computer as a first information processing apparatus operated by a user to execute a process comprising:
connecting a second information processing apparatus operated by the user to the first information processing apparatus using the first information processing apparatus;
detecting occurrence of an event involving presentation of message information in the first information processing apparatus;
while the user is operating the first information processing apparatus, causing a first display included in the first information processing apparatus to present as a main window a window presented on the first display by the first information processing apparatus;
while the user is operating the second information processing apparatus, causing the first display to present as a main window a window presented by the second information processing apparatus;
in response to detection of occurrence of the event in any of the information processing apparatuses, identifying a window presented as the main window on the first display; and
in response to the detection of the occurrence of the event, presenting, in the main window, event notification information reporting the occurrence of the event when the information processing apparatus whose window is presented as the main window on the first display has not detected the occurrence of the event.

What is claimed is:

1. An information processing system comprising:
a first processor included in a first information processing apparatus operated by a user; and
a second processor included in a second information processing apparatus operated by the user using the first information processing apparatus connected to the second information processing apparatus,
wherein the second processor is configured to:
while the first information processing apparatus is connected, in response to detection of occurrence of an event involving presentation of message information in the second information processing apparatus, notify the first processor of the occurrence of the event; and
wherein the first processor is configured to:
detect occurrence of the event in the first information processing apparatus;
while the user is operating the first information processing apparatus, cause a first display included in the first information processing apparatus to present as a main window a window presented on the first display by the first information processing apparatus;
while the user is operating the second information processing apparatus, cause the first display to present as a main window a window presented by the second information processing apparatus;
in response to detection of occurrence of the event in any of the information processing apparatuses, identify a window presented as the main window on the first display; and
in response to the detection of the occurrence of the event, present, in the main window, event notification information reporting the occurrence of the event when the information processing apparatus whose window is presented as the main window on the first display has not detected the occurrence of the event.

2. The information processing system according to claim 1,
wherein the event notification information includes a message indicating the information processing apparatus that has detected the occurrence of the event.

3. The information processing system according to claim 2,
wherein the first processor is configured to present a guide window including the event notification information and a selection button for designating as a main window a window in which the message information is presented.

4. The information processing system according to claim 1,
wherein the first processor is configured to present, in the main window, event handling information indicating the information processing apparatus to be used to handle the event when the information processing apparatus whose window is presented as the main window on the first display is different from the information processing apparatus to be used to handle the event whose occurrence has been detected.

5. The information processing system according to claim 4,
wherein the first processor is configured to, by referring to the event handling information in which description of the event is associated with the information processing apparatus to be used to handle the event, determine whether the information processing apparatus whose window is presented as the main window on the first display is the same as the information processing apparatus to be used to handle the event whose occurrence has been detected.

6. The information processing system according to claim 4,
wherein the first processor is configured to present a guide window including the event handling information and a selection button for designating as a main window a window presented by the information processing apparatus to be used to handle the event.

7. The information processing system according to claim 4,
wherein the first processor is configured to, when a window of the information processing apparatus to be used to handle the event is presented as a sub-window on the first display, provide indication for prompting presentation of the sub-window as a main window.

8. The information processing system according to claim 7,
wherein the first processor is configured to control a position at which a window for presenting the event handling information is presented.

9. An information processing system comprising:
a first processor included in a first information processing apparatus operated by a user,
wherein the first processor is configured to:
connect a second information processing apparatus operated by the user to the first information processing apparatus using the first information processing apparatus;
detect occurrence of an event involving presentation of message information in the first information processing apparatus;
while the user is operating the first information processing apparatus, cause a first display included in the first information processing apparatus to present as a main window a window presented on the first display by the first information processing apparatus;
while the user is operating the second information processing apparatus, cause the first display to present as a main window a window presented by the second information processing apparatus;
in response to detection of occurrence of the event in any of the information processing apparatuses, identify a window presented as the main window on the first display; and
in response to the detection of the occurrence of the event, present, in the main window, event notification information reporting the occurrence of the event when the information processing apparatus whose window is presented as the main window on the first display has not detected the occurrence of the event.

10. The information processing system according to claim 1,
wherein the event is an error that occurs in the first information processing apparatus, the second information processing apparatus, or an apparatus connected to the first information processing apparatus.

11. The information processing system according to claim 9,
wherein the event is an error that occurs in the first information processing apparatus, the second information processing apparatus, or an apparatus connected to the first information processing apparatus.

12. A cloud printing service system comprising:
the information processing system according to claim 1;
a server configured to provide a cloud printing service; and
a printing apparatus connected to the first information processing apparatus,
wherein a print agent application is installed on the first information processing apparatus,
a cloud printing driver is installed on the second information processing apparatus, and
the first information processing apparatus is configured to, in response to a user operation, acquire a job registered in the server by the second information processing apparatus and cause the printing apparatus to print the job.

13. A cloud printing service system comprising:
the information processing system according to claim 2;
a server configured to provide a cloud printing service; and
a printing apparatus connected to the first information processing apparatus,
wherein a print agent application is installed on the first information processing apparatus,
a cloud printing driver is installed on the second information processing apparatus, and
the first information processing apparatus is configured to, in response to a user operation, acquire a job registered in the server by the second information processing apparatus and cause the printing apparatus to print the job.

14. A cloud printing service system comprising:
the information processing system according to claim 3;
a server configured to provide a cloud printing service; and
a printing apparatus connected to the first information processing apparatus,
wherein a print agent application is installed on the first information processing apparatus,
a cloud printing driver is installed on the second information processing apparatus, and
the first information processing apparatus is configured to, in response to a user operation, acquire a job registered in the server by the second information processing apparatus and cause the printing apparatus to print the job.

15. A cloud printing service system comprising:
the information processing system according to claim 4;
a server configured to provide a cloud printing service; and
a printing apparatus connected to the first information processing apparatus,
wherein a print agent application is installed on the first information processing apparatus,
a cloud printing driver is installed on the second information processing apparatus, and
the first information processing apparatus is configured to, in response to a user operation, acquire a job registered in the server by the second information processing apparatus and cause the printing apparatus to print the job.

16. A cloud printing service system comprising:
the information processing system according to claim 5;
a server configured to provide a cloud printing service; and
a printing apparatus connected to the first information processing apparatus,
wherein a print agent application is installed on the first information processing apparatus,
a cloud printing driver is installed on the second information processing apparatus, and
the first information processing apparatus is configured to, in response to a user operation, acquire a job registered in the server by the second information processing apparatus and cause the printing apparatus to print the job.

17. A cloud printing service system comprising:
the information processing system according to claim 6;
a server configured to provide a cloud printing service; and
a printing apparatus connected to the first information processing apparatus,
wherein a print agent application is installed on the first information processing apparatus,
a cloud printing driver is installed on the second information processing apparatus, and
the first information processing apparatus is configured to, in response to a user operation, acquire a job registered in the server by the second information processing apparatus and cause the printing apparatus to print the job.

18. A cloud printing service system comprising:
the information processing system according to claim 7;
a server configured to provide a cloud printing service; and
a printing apparatus connected to the first information processing apparatus,
wherein a print agent application is installed on the first information processing apparatus,
a cloud printing driver is installed on the second information processing apparatus, and
the first information processing apparatus is configured to, in response to a user operation, acquire a job registered in the server by the second information processing apparatus and cause the printing apparatus to print the job.

19. A cloud printing service system comprising:
the information processing system according to claim 8;
a server configured to provide a cloud printing service; and
a printing apparatus connected to the first information processing apparatus,
wherein a print agent application is installed on the first information processing apparatus,
a cloud printing driver is installed on the second information processing apparatus, and
the first information processing apparatus is configured to, in response to a user operation, acquire a job registered in the server by the second information processing apparatus and cause the printing apparatus to print the job.

20. A non-transitory computer readable medium storing a program causing a computer as a first information processing apparatus operated by a user to execute a process comprising:
connecting a second information processing apparatus operated by the user to the first information processing apparatus using the first information processing apparatus;
detecting occurrence of an event involving presentation of message information in the first information processing apparatus;
while the user is operating the first information processing apparatus, causing a first display included in the first information processing apparatus to present as a main window a window presented on the first display by the first information processing apparatus;
while the user is operating the second information processing apparatus, causing the first display to present as a main window a window presented by the second information processing apparatus;
in response to detection of occurrence of the event in any of the information processing apparatuses, identifying a window presented as the main window on the first display; and
in response to the detection of the occurrence of the event, presenting, in the main window, event notification information reporting the occurrence of the event when the information processing apparatus whose window is presented as the main window on the first display has not detected the occurrence of the event.
